(19) United States
(12) Patent Application Publication
(10) Pub. No.: US 2026/0364710 A1
(43) Pub. Date: Nov. 19, 2026

(54) TANK COMPRISING AT LEAST ONE WELDED SEAM OBTAINED USING FRICTION WELDING AND AT LEAST ONE ACCESS TUBE FOR A FOLLOWING SUPPORT, AND METHOD FOR ASSEMBLING SUCH A TANK

(71) Applicant: Airbus Operations SAS, TOULOUSE (FR)

(72) Inventor: Paul D'HULSTER, TOULOUSE (FR)

(21) Appl. No.: 19/673,509

(22) Filed: May 11, 2026

(30) Foreign Application Priority Data
May 14, 2025 (FR) FR2505118

(51) Int. Cl. B23K 20/12; B23K 101/06; B23K 101/12

(52) U.S. Cl. CPC B23K 20/129; B23K 20/122; B23K 2101/06; B23K 2101/12

(57) ABSTRACT

A tank with a peripheral welded seam, obtained using friction welding, connecting a cylindrical body and an end wall, and at least one access tube which extends between a first end opening into the tank and a second end, the interior faces of the tank and of the access tube having at least one tracking line for a welding head, which extends continuously and without singularities or sharp angles, between the second end of the access tube and the peripheral welding line, the access tube having an access cross section configured to allow a following support, coupled to the welding head, to pass along the access tube. Also a method of assembling such a tank.

### CROSS-REFERENCE TO REALTED APPLCATIONS

This application claims the benefit of French Patent Application Number FR2505118, filed on May 14, 2025, the entire disclosure of which is incorporated herein by way of reference.

### Field of the Invention

The present application relates to a tank comprising at least one line of welding obtained using friction welding and at least one access tube for a following support, and to a method for assembling such a tank.

### Background of the Invention

According to one embodiment visible in FIG. 1, a tank 10 comprises a tubular body 12 and first and second domes 14, 16 which are attached to the ends of the tubular body 12 using welding. According to one configuration, the tubular body 12 comprises two half-cylinders 12.1, 12.2 which are joined together using welding.

A friction welding method is preferred over other welding methods because this offers better mechanical properties, greater stability and can be performed at a higher speed.

This welding method uses a rotary welding head pressed against the first faces of the parts that are to be assembled and moved along the junction zone of said parts, a backing plate being positioned against the second faces (the opposite faces to the first faces) of the parts that are to be assembled in order to react the forces generated by the welding head.

The half-cylinders 12.1, 12.2 of the tubular body 12 and the first dome 14 can be assembled using a friction welding method. According to the prior art, the second dome 16 is not assembled using a friction welding method because it is not possible to position a backing plate inside the tank to react the forces generated by the welding head because this backing plate cannot be removed from the tank which, at the end of the welding operation, is sealed closed.

According to one embodiment visible in FIG. 2 and described in document FR3129861, a tank 10 comprises a connecting ring 18 connecting a first end 12a of the tubular body 12 and the second dome 16. This connecting ring 18 comprises:
a first cylindrical portion 20 pushed into the first end 12a of the tubular body 12,
at least one shoulder 22 contiguous with the first cylindrical portion 20 and projecting towards the exterior zone of the tank 10 with respect to said tank,
a second cylindrical portion 24 butted up against the edge of the second dome 16,
at least one annulus-shaped transverse web 26 comprising an exterior edge 26.1 connected to the first cylindrical portion 20 and an interior edge 26.2 directed toward the interior zone of the tank 10, said transverse web 26 being positioned approximately in the same transverse plane as the shoulder 22 and enhancing the rigidity of said connecting ring 18.

During a first friction welding step, the connecting ring 18 is attached to the second dome 16 by a first peripheral weld 28. During this first friction welding step, a backing plate 30 is pressed against the interior faces of the connecting ring 18 and of the second dome 16.

After the backing plate 30 has been removed, the first cylindrical portion 20 of the connecting ring 18 is pushed into the first end 12a of the tubular body 12 and then, during a second friction welding step, the connecting ring 18 is connected to the tubular body 12 by a second peripheral weld 32 positioned along a junction plane situated between the first shoulder 22 and the first end 12a of the tubular body 12. During this second friction welding step, the transverse web 26 of the connecting ring 18 acts as backing plate.

Although this solution does make it possible to obtain a tank by assembling various parts using friction welding alone, it is not entirely satisfactory because it leads to an increase in the mass of the tank and in the time and cost of manufacture thereof as a result of the presence of the connecting ring 18 and of the first and second peripheral welds 28, 32.

### SUMMARY OF THE INVENTION

The present invention is intended to overcome some or all of the drawbacks in the prior art.

To this end, one subject of the invention is a tank comprising a cylindrical body, at least one end wall and at least one peripheral line of welding connecting the cylindrical body and the end wall, the tank separating interior and exterior zones and having an interior face.

According to the invention, the tank comprises at least one access tube which extends between a first end opening into the tank and a second end, said access tube being configured to allow the exterior and interior zones of the tank to communicate with one another and having an interior face, the interior faces of the tank and of the access tube comprising at least one tracking line for a welding head, which extends continuously and without singularities or sharp angles, between the second end of the access tube and the peripheral welding line, the access tube having an access cross section configured to allow a following support to pass along the access tube.

This solution enables the tank to be closed by creating a peripheral welded seam using friction welding without the addition of a connecting ring by connecting the cylindrical body and the end wall to one another directly.

According to another feature, at least at the tracking line, the tank and the access tube have a thickness that is substantially constant.

According to another feature, the access tube is secured to the second end wall.

According to another feature, the tank has a tank axis. To complement this, the access tube has a tube axis parallel to the tank axis.

According to another feature, the access tube is secured to the cylindrical body.

According to another feature, the access tube has a tube axis positioned in a transverse plane perpendicular to the tank axis.

According to another feature, the access tube is rectilinear and its interior face has at least one line tangential to the interior face of the tank, said line forming the tracking line.

According to another feature, the access tube comprises an emergent portion which has an interior face, and a curved connecting portion which connects the emergent portion and the tank, said connecting portion having an interior face which comprises at least one line tangential at a first point to the interior face of the emergent portion and at a second point to the interior face of the tank, said line forming the tracking line.

Another subject of the invention is a method of assembling a tank according to one of the foregoing features, and comprising:
a step of positioning a welding head and a following support at the second end of the access tube,
a step of moving the welding head along the tracking line until it reaches the peripheral welding line, the following support, positioned in the access tube, following the welding head,
a friction welding step performed by moving the welding head and the following support, which are positioned facing one another, around the tank so as to create the peripheral line of welding,
a step of moving the welding head along the tracking line until it reaches the second end of the access tube, the following support, positioned in the access tube, following the welding head.

According to another feature, the assembly method comprises at least one step of fitting a connection end piece at the second end of the access tube.

### BRIEF DESCRIPTION OF THE DRAWINGS

Further features and advantages will become apparent from the following description of the invention, which is given by way of example only, with reference to the appended drawings, in which:

FIG. 1 is a schematic representation of the various steps in the manufacture of a tank, illustrating an embodiment of the prior art,

FIG. 2 is a cross section through part of a tank, illustrating another embodiment of the prior art,

FIG. 3 is a perspective view of a tank, illustrating one embodiment of the invention,

FIG. 4 is a perspective view of part of a tank, with part of an end wall cut away, during a welding operation and illustrating one embodiment of the invention,

FIG. 5 is a face-on view of part of the tank visible in FIG. 4 with part of the end wall cut away, during the welding operation,

FIG. 6 is a perspective view of part of a tank during a welding operation, illustrating another embodiment of the invention,

FIG. 7 is a perspective view of part of a tank during a welding operation, illustrating another embodiment of the invention,

FIG. 8A is a schematic representation of a first phase of a friction-welding method, illustrating one embodiment of the invention;

FIG. 8B is a schematic representation of a second phase of a friction-welding method, illustrating one embodiment of the invention;

FIG. 8C is a schematic representation of a third phase of a friction-welding method, illustrating one embodiment of the invention;

FIG. 8D is a schematic representation of a fourth phase of a friction-welding method, illustrating one embodiment of the invention;

FIG. 8E is a schematic representation of a fifth phase of a friction-welding method, illustrating one embodiment of the invention; and,

FIG. 8F is a schematic representation of a sixth phase of a friction-welding method, illustrating one embodiment of the invention.

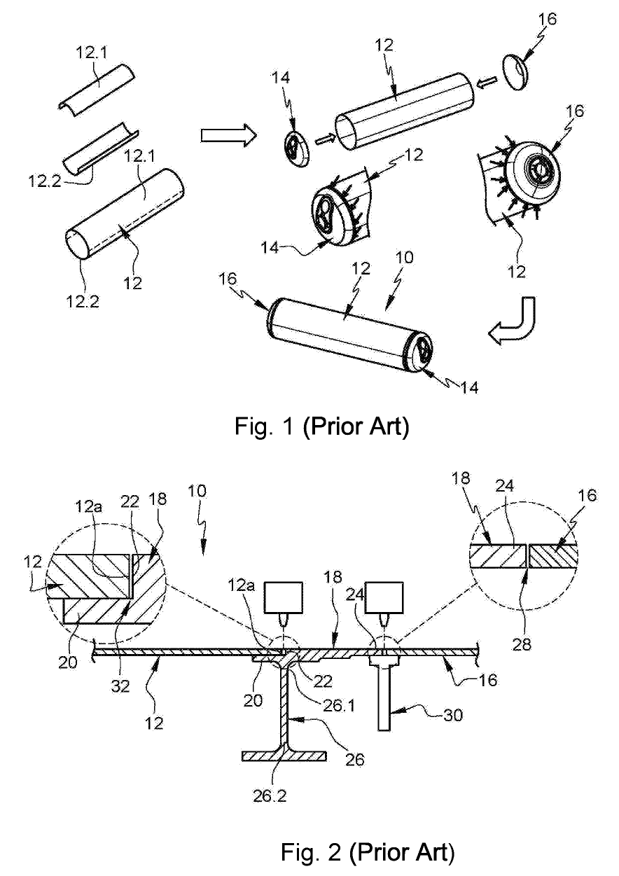

### DETAILED DESCRIPTION OF THE PREFERRED EMBODIMENTS

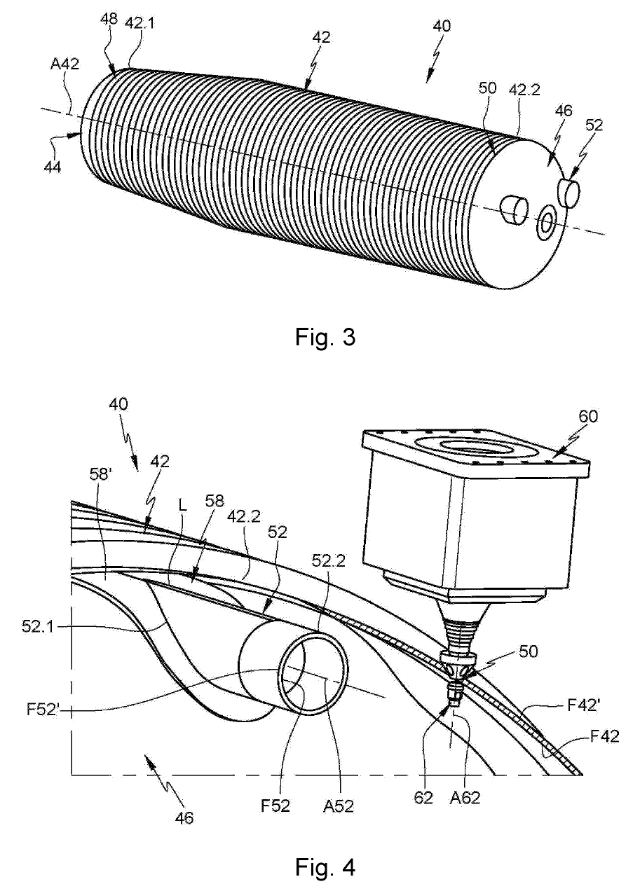

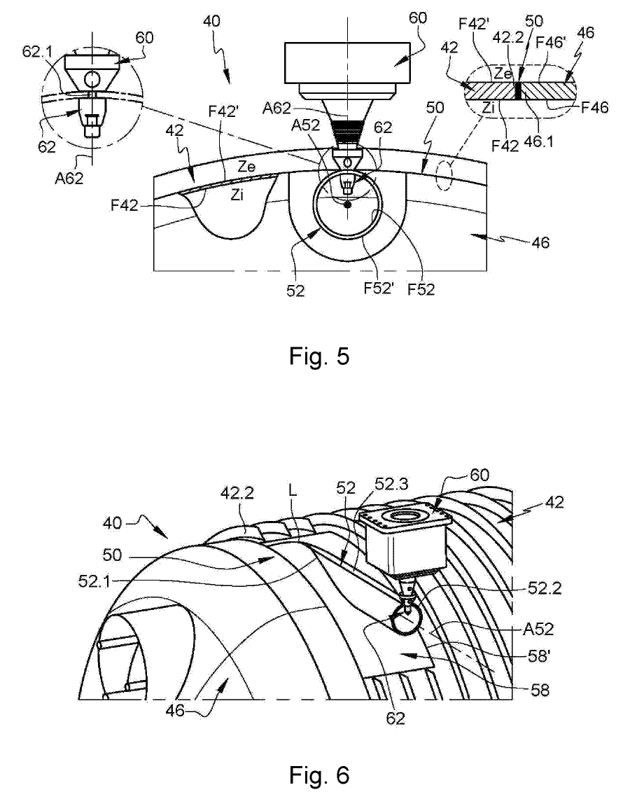

According to one embodiment visible in FIG. 3, a cylindrical tank 40 comprises a cylindrical tubular body 42 which extends between first and second ends 42.1, 42.2, a first end wall 44 attached in a sealed manner to the first end 42.1 and a second end wall 46 attached in a sealed manner to the second end 42.2. When closed, the tank delimits an interior zone Zi and an exterior zone Ze, these being visible in FIGS. 4 and 5. The tubular body 42 has an interior face F42 oriented toward the interior zone Zi and an exterior face F42’ oriented toward the exterior zone Ze.

The tubular body 42 has a tank axis A42. For the remainder of the description, a longitudinal direction is parallel to the tank axis A42. A transverse plane is a plane perpendicular to the tank axis A42.

According to one configuration, the tubular body 42 comprises two half-cylinders which are joined together in a sealed manner to obtain the tubular body 42. According to one procedure, the two half-cylinders are connected using friction welding.

According to one arrangement, the first and second end walls 44, 46 are each dome shaped. Of course, the invention is not limited to this geometry for the first and second end walls 44, 46. Whatever the embodiment, each of the first and second end walls 44, 46 has one end that comprises a circular edge face 46.1, positioned in a transverse plane, and interior and exterior faces F46, F46'. The interior faces F42, F46 of the tubular body 42 and of the first and second end walls 44, 46 form the interior face of the tank 40. The exterior faces F42', F46' of the tubular body 42 and of the first and second end walls 44, 46 form the exterior face of the tank 40.

According to one embodiment, the first and second end walls 44, 46 are connected to the tubular body 42 by first and second peripheral lines of welding 48, 50 respectively. On each side of the first or second peripheral line of welding 48, 50, the tubular body 42 and the first or second end wall 44, 46 have substantially (+/- 10%) the same thickness.

A method for manufacturing a tank 40 comprises at least a step of producing the tubular body 42 and the first and second end walls 44, 46, a first welding step for creating the first peripheral line of welding 48 that connects the tubular body 42 and the first end wall 44, then a second welding step for creating the second peripheral line of welding 50 that connects the tubular body 42 and the second end wall 46.

According to one procedure, the first welding step is a friction welding step using a backing plate positioned against the interior faces F42 of the tubular body 42 and of the first end wall 44, a welding head being moved in the exterior zone Ze against the exterior faces F42' of the tubular body 42 and of the first end wall 44. This first welding step is not described further because it may be identical to that of the methods of the prior art.

According to one particular feature of the invention, the tank 40 comprises at least one access tube 52 which extends between a first end 52.1 opening into the tank 40 and a second end 52.2, said access tube being configured to allow the exterior and interior zones Ze, Zi of the tank 40 to communicate with one another.

According to one embodiment, the access tube 52 is cylindrical and comprises interior and exterior faces F52, F52' that are substantially cylindrical and concentric. Of course, the invention is not limited to this geometry for the access tube 52. The latter may comprise at least one flat zone. Whatever the embodiment, the access tube 52 comprises at least one interior face F52 and at least one exterior face F52'.

According to one configuration, the access tube 52 has a thickness, corresponding to the distance separating the interior and exterior faces F52, F52', that is substantially equal to the thickness of the tubular body 42 and of the second end wall 46 at the second peripheral welding line 50.

The access tube 52 has a tube axis A52 that is substantially parallel to and coaxial with the interior and exterior faces F52, F52'.

According to a first embodiment visible in FIGS. 4, 5 and 8A-8F, the access tube 52 is secured to the second end wall 46 and has a tube axis A52 parallel to the longitudinal direction or to the tank axis A42.

According to this first embodiment, the access tube 52 is positioned with respect to the second end wall 46 in such a way that it has, at its interior face F52, at least one line tangential to the interior face F46 of the second end wall 46.

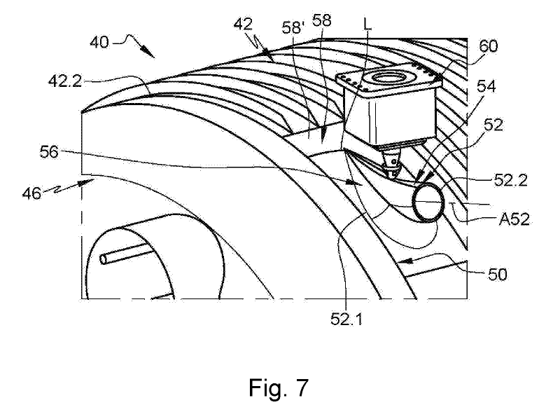

According to a second embodiment visible in FIGS. 6 and 7, the access tube 52 is secured to the tubular body 42 and has a tube axis A52 positioned in a transverse plane perpendicular to the tank axis A42.

According to a configuration visible in FIG. 6, the access tube 52 is positioned with respect to the tubular body 42 in such a way that it has, at its interior face F52, at least one line tangential to the interior face F42 of the tubular body 42.

According to another configuration, the access tube 52 comprises a rectilinear and constant-section emergent portion 54 which has interior and exterior first faces that are cylindrical and coaxial with one another and with the tube axis A52, and a flared connecting portion 56 connecting the emergent portion 54 and the tubular body 42, the connecting portion 56 having an interior face that is continuous with the interior face of the emergent portion 54 and the interior face F42 of the tubular body 42. According to this configuration, the connecting portion 56 has, at its interior face, at least one line tangential at a first point to the interior face F42 of the tubular body 42 and at a second point to the interior face of the emergent portion 54.

This configuration is not limited to an access tube 52 connected to the tubular body 42. According to another configuration, the access tube 52 is connected to the second end wall 46 and comprises a rectilinear and constant-section emergent portion 54 which has interior and exterior first faces that are cylindrical and coaxial with one another and with the tube axis A52, and a curved connecting portion 56 connecting the emergent portion 54 and the second end wall 46, the connecting portion 56 having an interior face that is continuous with the interior face of the emergent portion 54 and with the interior face F46 of the end wall 46. According to this configuration, the connecting portion 56 has, at its interior face, a line tangential at a first point to the interior face F46 of the second end wall 46 and at a second point to the interior face of the emergent portion 54.

According to these various embodiments, the access tube 52 comprises a first end connected to the tank 40 and opening into the interior zone Zi thereof, and a second open end enabling the interior and exterior zones Zi, Ze of the tank 40 to communicate with one another, the access tube 52 having an interior face F52 connected to the interior face of the tank 40 by at least one continuous line where the access tube 52 has a thickness that is substantially constant. This continuous line does not intersect any edge corner and has no singularity or sharp angle namely any point having two different tangents.

According to first embodiments visible in FIGS. 4 to 6 and 8A-8F, the access tube 52 is rectilinear and, on its interior face F52, has at least one line or generatrix tangential to the interior face of the tank 40.

According to a second embodiment visible in FIG. 7, the access tube 52 comprises an emergent portion 54 and a curved connecting portion 56, which connects the emergent portion 54 and the tank 40, said connecting portion having, on its interior face, at least one line tangential at a first point to the interior face of the emergent portion 54 and at a second point to the interior face of the tank 40.

According to one procedure, a component 58 comprising the access tube 52 and a part 58' of the tubular body 42 or of the end wall 46 is produced separately from the rest of the tubular body 42 or from the end wall 46 and is then connected to the rest of the tubular body 42 or of the end wall 46 using a friction welding method that employs a backing plate. Of course, the invention is not limited to this embodiment of the procedure for connecting the access tube 52 to the tank 40. Thus, the tubular body 42 or the end wall 46 and the access tube 52 could be produced as a single piece, in the one same manufacturing step, rather than being assembled later.

According to the invention, the second welding step for producing the second peripheral line of welding 50 that connects the tubular body 42 and the second end wall 46 is performed using friction welding. During this friction welding operation, a welding head 60 is positioned in the exterior zone Ze and is moved along the second peripheral welding line 50, in contact with the exterior faces F42', F46' of the tubular body 42 and of the second end wall 46. To complement this, a following support 62 is positioned in the interior zone Zi and is configured to be coupled to the welding head 60 and to follow it while remaining in contact with the interior faces F42, F46 of the tubular body 42 and of the second end wall 46.

According to one embodiment, the following support 62 is mechanically connected to the welding head 60 by a rigid and cylindrical mechanical connection 62.1.

Whatever the embodiment, the following support 62 has a given geometry and given dimensions. By way of indication, the following support 62 has a shape that is approximately axisymmetrical, and has a support axis A62.

According to one particular feature, the access tube 52 has an access cross section (delimited by its interior face F52) configured to allow the following support 62 to pass along the access tube 52 in order to track from the exterior zone Ze toward the interior zone Zi, or vice versa.

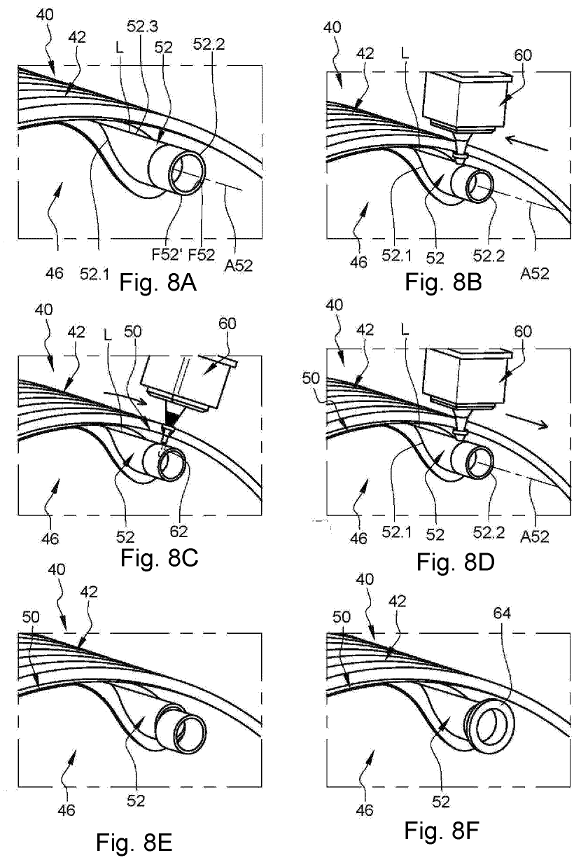

According to one procedure employed in the second welding step, during a first phase of positioning, the welding head 60 is positioned at the second end of the access tube 52, outside the access tube 52, the following support 62 being positioned in the access tube 52. During a second phase of movement, the welding head 60 is moved until it reaches the second peripheral welding line 50, as illustrated in FIG. 8B. Given that the tracking path followed is continuous (with no singularities or sharp angles) on the interior faces of the access tube 52 and of the tank 40, the following support 62 is able to follow the welding head 60.

During a third phase of welding, as illustrated in FIG. 8C, the welding head 60 moves around the entire circumference of the tank 40 so as to create the second peripheral line of welding 50. When this last phase has been completed, during a fourth phase of movement, the welding head 60 is moved along the access tube 52, as illustrated in FIG. 8D until it reaches the second end 52.2 of the access tube 52. Given that the tracking path followed is continuous (with no singularities or sharp angles) on the interior faces of the access tube 52 and of the tank 40, the following support 62 is able to follow the welding head 60.

According to a first mode of operation, the welding head 60 is activated and rotated during the third phase of welding but also during the second and fourth phases of movement along the access tube 52 so as to penetrate into the material. According to a second mode of operation, the welding head 60 is activated and rotated during the third phase of welding and the fourth phase of movement, the access tube initially comprising a slot 52.3 to allow the mechanical connection 62.1 to pass during the second phase of movement.

After the welding operation, the access tube 52 may be permanently plugged using a plug. In that case, the access tube 52 is used only for inserting and extracting the following support 62.

According to another embodiment illustrated by FIGS. 8E and 8F, the access tube 52 may be cut off and fitted with a connection end piece 64. In that case, the access tube 52 has a connection function after having permitted the insertion and extraction of the following support 62. According to this other embodiment, the assembly method comprises at least one step of fitting a connection end piece 64 at the second end 52.2 of the access tube 52.

Of course, the invention is not limited to the embodiments described above. Whatever the embodiment, the tank 40 separates exterior and interior zones Ze, Zi, has an interior face and comprises a cylindrical body 42, at least one end wall 46, at least one peripheral line of welding 50 connecting the cylindrical body 42 and the end wall 46 as well as at least one access tube 52 which extends between a first end 52.1 opening into the tank 40 and a second end 52.2, said access tube 52 being configured to allow the exterior and interior zones Ze, Zi of the tank 40 to communicate with one another and having an interior face F52, the interior faces of the tank 40 and of the access tube 52 comprising at least one tracking line L for a welding head 60, which extends continuously and without singularities or sharp angles, between the second end 52.2 of the access tube 52 and the peripheral welding line 50. According to one configuration, at least at this tracking line L, the tank 40 and the access tube 52 have a thickness that is substantially constant.

A method of assembling a tank 40 comprises:
a step of positioning a welding head 60 and a following support 62 at the second end 52.2 of the access tube 52,
a step of moving the welding head 60 along the tracking line L until it reaches the peripheral welding line 50, the following support 62, positioned in the access tube 52, following the welding head 60,
a friction welding step performed by moving the welding head 60 and the following support 62, which are positioned facing one another, around the entire circumference of the tank 40 so as to create the peripheral line of welding 50,
a step of moving the welding head 60 along the tracking line L until it reaches the second end 52.2 of the access tube 52, the following support 62, positioned in the access tube 52, following the welding head 60.

This method of assembly makes it possible to create a peripheral welded seam for closing the tank 40 using a friction welding technique and to do so without the addition of a connecting ring.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tank comprising:
a cylindrical body;
an end wall;
a peripheral welding line connecting the cylindrical body and the end wall, the tank separating an interior zone and an exterior zone and having an interior face;
an access tube extending between a first end opening into the tank and a second end, the access tube configured to allow the exterior zone and the interior zone of the tank to communicate with one another and having an interior face,
wherein the interior face of the tank and the interior face of the access tube comprises a tracking line for a welding head, the tracking line extending continuously and without singularities or sharp angles, between the second end of the access tube and the peripheral welding line, and
wherein the access tube comprises an access cross section configured to allow a support to pass along the access tube.

2. The tank as claimed in claim 1, wherein at least at the tracking line, the tank, and the access tube have a thickness that is substantially constant.

3. The tank as claimed in claim 1, wherein the access tube is secured to the end wall.

4. The tank as claimed in claim 1, wherein the tank has a tank axis and wherein the access tube has a tube axis parallel to the tank axis.

5. The tank as claimed in claim 1, wherein the access tube is secured to the cylindrical body.

6. The tank as claimed in claim 1, wherein the tank has a tank axis and wherein the access tube has a tube axis positioned in a transverse plane perpendicular to the tank axis.

7. The tank as claimed in claim 1, wherein the access tube is rectilinear and the interior face of the access tube has a line tangential to the interior face of the tank, the line forming the tracking line.

8. The tank as claimed in claim 1, wherein the access tube comprises an emergent portion which has an interior face, and a curved connecting portion connecting the emergent portion and the tank, the connecting portion having an interior face which comprises a line tangential at a first point to the interior face of the emergent portion and at a second point to the interior face of the tank, the line forming the tracking line.

9. A method for assembling the tank as claimed in claim 1, comprising:
positioning a welding head and the support at the second end of the access tube;
moving the welding head along the tracking line until the welding head reaches the peripheral welding line, the support, positioned in the access tube, following the welding head;
friction welding performed by moving the welding head and the support, which are positioned facing one another, around the tank so as to form the peripheral welding line; and,
moving the welding head along the tracking line until the welding head reaches the second end of the access tube, the support, positioned in the access tube, following the welding head.

10. The method as claimed in claim 9, further comprising:
fitting a connection end piece at the second end of the access tube.
